(19) United States
(12) Patent Application Publication
(10) Pub. No.: US 2010/0162878 A1
(43) Pub. Date: Jul. 1, 2010

(54) MUSIC INSTRUCTION SYSTEM

(75) Inventors: Gerhard H. Lengeling, Los Altos Hills, CA (US); Alexander Soren, San Francisco, CA (US); Jan-Hinnerk Helms, Hamburg (DE); Alexander H. Little, Woodside, CA (US); John Danty, Calgary (CA); Matthew C. Evans, San Francisco, CA (US); Timothy B. Martin, Sunnyvale, CA (US); Ole Lagemann, Hamburg (DE); Stefan Pillhofer, Hamburg (DE)

Correspondence Address: APPLE INC./BSTZ;BLAKELY SOKOLOFF TAYLOR & ZAFMAN LLP, 1279 OAKMEAD PARKWAY, SUNNYVALE, CA, 94085-4040, US

(73) Assignee: Apple Inc., Cupertino, CA (US)

(21) Appl. No.: 12/347,305

(22) Filed: Dec. 31, 2008

(51) Int. Cl. G09B 15/02

(52) U.S. Cl. 84/483.2

(57) ABSTRACT

A song audio is played and a graphical representation of a musical instrument contributing to the audio is displayed. A fingering display is overlayed on the graphical representation of the instrument during the playing of song. The fingering display is synchronized to the song audio. During the playing of the song audio, the tempo of the song is adjusted. The pitch of the song is substantially preserved in real-time despite the tempo adjustment. In addition, the synchronization between the fingering display and the audio are maintained in real-time in view of the adjusted tempo.

### FIELD

Embodiments described herein relate to graphical user interfaces (GUIs) for audio processing and more particularly to GUIs associated with processing audio from musical instruments.

### BACKGROUND

In-person music instruction can be expensive and/or inconvenient because of travel and/or scheduling. Additionally, with group instruction, it can be frustrating to follow a group pace for instruction that may be too fast or too slow for a particular person's skills and abilities. Thus, students, musicians and other music hobbyists are increasingly using computers to improve, expand and strengthen their skills playing a variety of musical instruments. Various conventional computer programs exist to provide musical instruction.

One drawback of conventional music instruction programs is that the displays and/or user interfaces associated with these programs are not intuitive and/or they fail to recreate the visual cues and subtleties that can be critical for learning to play a musical instrument. Another drawback of conventional music instruction programs is that while a user may be able to go through various lessons at his/her own pace, the actual tempo of the music instruction frequently fails to provide adequate flexibility (e.g., accompaniment music may be too fast or too slow or cannot be changed dynamically on the fly). In other words, while these programs may provide convenience and/or cost savings, they ultimately fail to provide the same caliber of instruction that a real person can provide.

### SUMMARY OF THE DESCRIPTION

A song audio is played and a graphical representation of a musical instrument associated with the audio is displayed. For example, a song might include a guitar part; thus, a graphical representation of a guitar (or simply a guitar neck) might be displayed. A fingering display is overlayed on the graphical representation of the instrument during the playing of song. Using the example of a guitar, a fingering of which strings to play with which fingers on which frets is displayed. The strings may also visually vibrate. The fingering display is synchronized to the song audio. During the playing of the song audio, the tempo of the song is adjusted. The pitch of the song is substantially preserved in real-time despite the tempo adjustment. In addition, the synchronization between the fingering display and the audio are maintained in real-time in view of the adjusted tempo.

### BRIEF DESCRIPTION OF DRAWINGS

The following description includes discussion of figures having illustrations given by way of example of implementations of embodiments of the invention. The drawings should be understood by way of example, not by way of limitation. As used herein, references to one or more “embodiments” are to be understood as describing a particular feature, structure, or characteristic included in at least one implementation of the invention. Thus, phrases such as “in one embodiment” or “in an alternate embodiment” appearing herein describe various embodiments and implementations of the invention, and do not necessarily all refer to the same embodiment. However, they are also not necessarily mutually exclusive.

FIG. 1 is a block diagram illustrating a system according to various embodiments.

FIG. 2 is a flow diagram of operation in a system according to various embodiments.

FIG. 3 is block diagram illustrating a suitable computing environment for practicing various embodiments.

FIG. 4 is block diagram illustrating a suitable computing environment for practicing various embodiments.

### DETAILED DESCRIPTION

As provided herein, methods, apparatuses, and systems provide improved graphical user interfaces for generating and/or recording music. The methods, apparatuses, and systems described herein can be used in conjunction with music/audio software such as, for example, Garage Band™ offered by Apple, Inc. of Cupertino, Calif. It will be understood in embodiments described herein that a song refers to any musical composition. Thus, a song file refers to a file associated with a musical composition and a song audio refers to the audio associated with the musical composition.

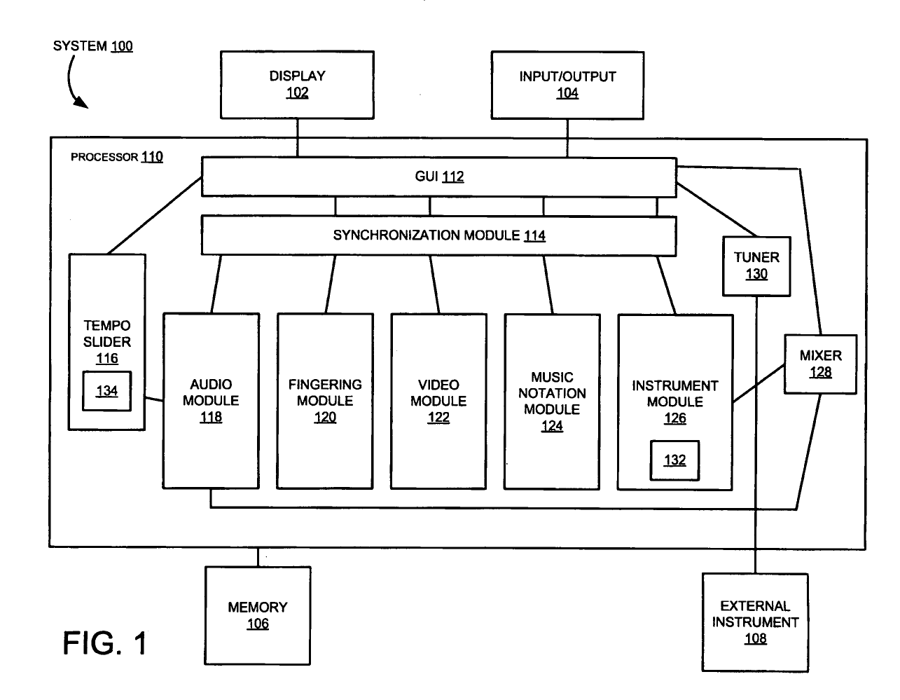

FIG. 1 is a block diagram illustrating a system according to various embodiments. System 100 includes various components for music instruction. It should be noted that the various components can all be included within processor 110 in various embodiments, however, certain components can be separate from processor 110 in alternate embodiments.

Graphical user interface (GUI) 112 allows a user (e.g., a music student) to interact with the various components of system 100 via display 102 and input/output 104. Various embodiments herein are described using a guitar as an example of a musical instrument used in teaching/learning. However, one of skill in the art will appreciate that other instruments can be using in various embodiments, including, but not limited, to pianos, drums, brass instruments (trumpet, French horn, etc.), reed instruments (saxophone, clarinet, etc.), etc.

Audio module 118 plays an audio of a song as part of a music lesson in various embodiments. The audio may be retrieved, for example, from a memory 106. The audio may be output via input/output 104. Video module 122 displays a video of the song in GUI 112. The video shows an instructor playing (e.g., a guitar) along with the audio. The video can include various views, angles, and/or perspectives of the instructor and/or the guitar.

Instrument module 126 includes a graphical element that is also displayed in GUI 112, the graphical element resembling at least a portion of a real musical instrument (e.g., a guitar) 108. For example, the graphical element of instrument module 126 might be a depiction of a fret board (including the strings) of a guitar. A fingering module 120 overlays instrument fingering for the song onto the graphical element of the guitar. For example, fingering module 120 might overlay highlighted icons (e.g., circles) at certain positions on the guitar fret board to indicate on which string and which fret to place a particular finger to play a note or a chord.

Instrument module 126 further includes a vibration component 132 that causes the strings on the graphical element of the guitar fret board to visually vibrate when a note or chord is to be played.

GUI 112 also displays musical notation corresponding the song audio based on a music notation module 124. Various music notation formats can be used in different embodiments. Some embodiments may use more than one music notation format at a time. Types of music notation used in various embodiments include, but are not limited to, tabbed notation, chord and/or chord grid notation, and classical notation.

The aforementioned modules and their corresponding displays in GUI 112 are synchronized by synchronization module 114. In embodiments where not all modules are in use (e.g., only audio module 118 and video module 122 are in use) only those modules need to be synchronized. As an example of the synchronization performed by synchronization module 114, instrument fingering (from fingering module 120) is synchronized with the song audio from audio module 118 such that the instrument fingerings for various notes and/or chords are displayed in GUI 112 at the same time that those same notes and/or chords are played in the song audio. Extending the example further, the visual vibrations of the guitar strings from vibration component 132 may also be synchronized such that the visual vibrations are displayed at the same time that the notes and/or chords associated with those vibrating strings are played in the song audio. In various embodiments, the synchronization occurs automatically without any user input.

In certain embodiments, the views, angles, perspectives, etc. of the video and instrument displays may change (e.g., dynamically) during the playing of a song. Additionally, the type of music notation being displayed may also change (e.g., between tab, chord, chord grid, classical notation, etc.) during the playing of the song.

System 100 also includes a tempo slider 116 that is displayed in GUI 112. A user may adjust the tempo of a song being played in real-time using input/output 104. For example, if a particular song is recorded/stored at 100 beats per minute (BPMs), but the tempo is too fast for the user (e.g., student) to keep the pace while playing along, the user can adjust the tempo down to, say, 85 BPMs. Some conventional music software provides for tempo adjustment. However, in embodiments described herein, tempo slider 116 includes a pitch stabilizer 134 to stabilize a pitch of the song audio in real-time in response to a tempo adjustment during playback of a song. Thus, a user can adjust the tempo during playback of a song while maintaining the proper pitch of the song. Synchronization module 114 maintains synchronization of the various synchronized modules in real-time when a tempo adjustment is made.

A tuner 130 is included in system 100 in various embodiments. Tuner 130 includes a graphical element displayed in GUI 112 that allows the user to perform various tuning operations. By connecting an external instrument (e.g., guitar) 108 to system 100, the user can play a note on the instrument and receive tuning feedback via GUI 112. For example, if a user plays an E note that is too low in pitch on a guitar, tuner 130 will indicate (via GUI 112) that the string needs to be tightened. Similarly, if the note is too high, tuner 130 will indicate that the string needs to be loosened.

Mixer 128 also includes a graphical element displayed in GUI 112, in this case allowing a user to apply configurable mixing parameters to the song audio and/or the external instrument audio. Mixing parameters can include, but are not limited to, master level, track levels, bass, treble, mid-range, and various effects (e.g. sustain, echo, etc.), etc.

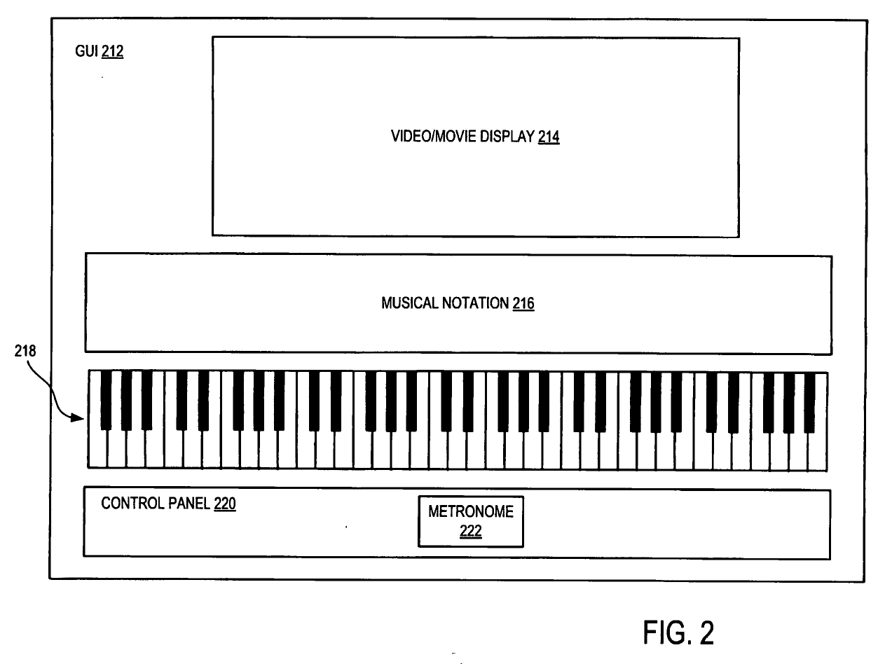

FIG. 2 is a block diagram illustrating a graphical user interface (GUI) display in a music instruction system according to various embodiments. For a given song (to be taught/learned), GUI 212 provides a variety of displays to facilitate the musical instruction. Video/movie display 214 displays a video of the song. In various embodiments, the video sets the foundation component to the song instruction. The video itself may be maintained in a single video file (e.g., a Quicktime® file). In certain embodiments, audio associated with the video is maintained in a separate audio file. The video includes one or more angles/views of an instructor playing the song on an instrument (e.g., guitar, piano, etc.). The video angle(s)/view(s) may change during playback of the song video. In some embodiments, each video angle is maintained in a separate video file.

In embodiments where the video includes multiple views, one view might be, for example, of the right hand playing the instrument (e.g., piano, guitar, etc.) while another view shown simultaneously might be of the left hand playing the instrument. Other combination of views including, but not limited to, body position, instrument views and the like are contemplated in various embodiments.

GUI 212 also includes a musical notation display 216. Musical notation 216 displays the musical notation associated with the song. Each different type of display is stored as a separate notation/score track. Examples of notations used in score tracks include, but are not limited to, full piano, right hand, left hand, piano chords, guitar grids, tablature (TAB), TAB+notation, and guitar chords. Thus, depending on the notation used, the musical notation associated with the song is displayed in sync with the song audio during playback. In other words, the timing of the particular notes/chords displayed in musical notation display 216 corresponds to the timing of those notes/chords being played in the song audio.

Instrument animation 218 displays an animated graphical representation of the musical instrument being practiced/learned. For example, if the music instruction is for playing the piano, then an animated graphical representation of a piano keyboard is displayed. A guitar fret board is another example of an instrument animation that can be displayed. In various embodiments (using the example of the piano), the piano keyboard may be animated to show the keys that are to be played during the playback of the corresponding song audio. Instrument animation display 218 may also include a fingering overlay to illustrate the exact fingering that should be used for particular notes, chords, melodies, etc. In embodiments where the instrument animation is of a string instrument (such as a guitar or bass guitar), the animation may cause the strings to visually vibrate corresponding to the notes in the song audio as though the strings were actually plucked by a user.

Control panel 220 may include a variety of user-selectable options (e.g., play, record, tempo adjust, etc.) related to interacting with the music instruction system. Included in control panel 220 is a metronome 222. Metronome can be turned on and off by a user, who can also adjust the tempo in various embodiments. In addition to the user controls, metronome 222 may be switched on and off automatically during playback of a song in some embodiments.

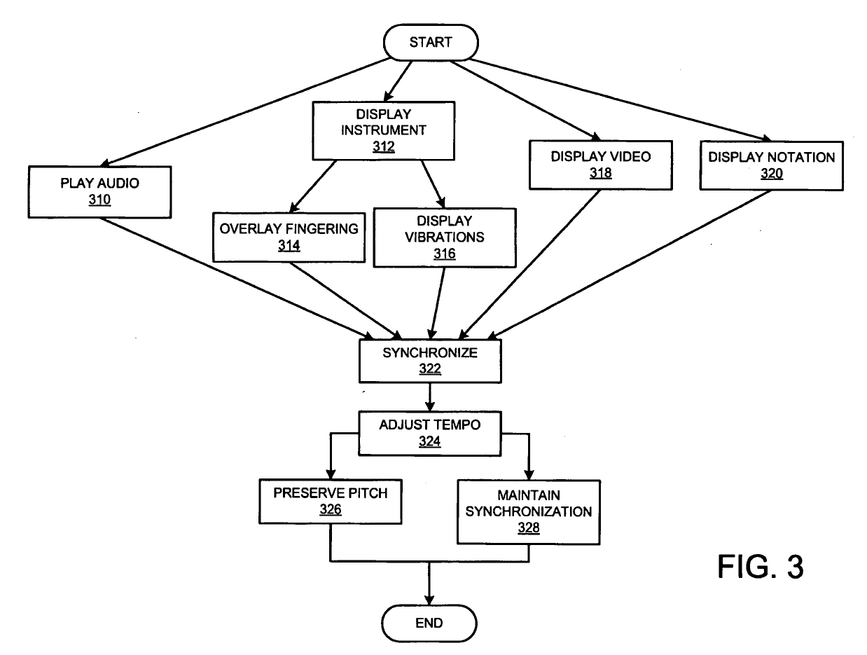

FIG. 3 is a flow diagram of operation in a system according to various embodiments. An audio of a song is played 310. The song audio may be a single instrument track or it may include a single instrument teaching track along with a full compliment of accompaniment instrumentation.

In various embodiments, a graphical representation of a musical instrument associated with the audio is displayed 312 in a graphical user interface. For example, the GUI might display a fret board of a guitar or a keyboard of a piano, synthesizer, organ, etc. The instrument display can change during playback of the song audio, either automatically or in response to user input. For example, the viewpoint or angle of display of the musical instrument can change to emphasize a particular portion of the musical instrument during music instruction.

A fingering display is overlayed 314 on the graphical representation of the musical instrument during playback of the song audio and is synchronized 322 with the song audio. The fingering overlay provides visual cues indicating which notes (e.g., on a guitar, piano, etc.) to play as the song progresses through playback. For example, if the song being played follows a simple I-IV-V chord structure, one chord for each of the first three measures, then the fingering overlay will provide a visual indication directly on the instrument display of which notes (e.g., strings/frets, keys, etc.) should be played by which fingers. The fingering overlay is synchronized so as to be displayed in real-time with the playback of the song. In some embodiments, the fingering overlay is displayed exactly synchronized with the true timing of the playback of various notes/chords. In other embodiments, the fingering overlay may be synchronized such that the fingering is displayed at a fixed interval before the actual notes/chords of the song are played during the audio playback. In this way, the user has a visual preview of the fingering to help the user be prepared to play the notes/chords at the proper times.

In embodiments where the musical instrument being displayed is a guitar or other string instrument (e.g., bass guitar, etc.), string vibrations of the musical instrument are displayed during playback of the audio of the song. The string vibrations are intended to reproduce the visual effect of a vibrating string, for example, after the string is plucked. In other words, the vibrations match the level, length and/or intensity of the notes being played in the song audio. The strings vibrations are also synchronized 322 to the song audio during playback of the song. The visual display of strings vibrating enhances the visual aspects of the music instruction, facilitating a better learning experience for the user. Similar to the display of string vibrations, embodiments having a keyboard display may have a synchronized display of key depressions to match notes being played in the song audio.

A video is displayed 318 of the same song for which the audio is played. The video includes at least one perspective of an instructor playing a musical instrument along with the song audio. In some embodiments, a recording of the instructor playing the song on the musical instrument is the song audio used during playback of the song. The video may include multiple camera angles/perspectives of the instructor playing the instrument. In embodiments having multiple angles/perspectives, the multiple angles/perspectives may be displayed simultaneously or one at a time at different points in the playback of the song audio and the video.

As with the other displays, the video display is synchronized 322 with the song audio. In other words, all displays are synchronized with the song audio.

A musical notation of the song is displayed 320. Displaying a musical notation refers to displaying the notes/chords and/or other components (key signature, loudness, softness, etc.) of a musical score. Displaying a musical notation may involve displaying a full musical score in some embodiments. Different types of notation can be used in different embodiments, including, but not limited to, a tab, a chord, a chord grid or a classical notation. The musical notation may change automatically during playback of a song. In some embodiments, a user may customize the musical notation view (e.g., the timing and/or notation type) displayed during playback of a song.

As with the other displays, the display of the musical notation is synchronized 322 with the song audio. Again, all displays are synchronized with the song audio.

In various embodiments, the tempo of the song audio that is currently playing is adjusted 324 (e.g., in response to user input) in real-time. In other words, it is not necessary to stop the playback of the audio to adjust the tempo; rather, the tempo may be adjusted “on the fly” while the song audio is playing. In conjunction with a tempo adjustment, the pitch of the song audio is substantially preserved in real-time. Pitch is preserved in various embodiments by performing a conversion of the sample rate of the song audio, followed by applying a pitch change algorithm. Unlike conventional systems that require pre-processing to preserve pitch in view of a tempo adjustment, embodiments described herein preserve the pitch in real-time in view of a real-time tempo adjustment.

Additionally, synchronization of the various displays (e.g., musical instrument animation, video, notation, etc.) is maintained with the song audio in view of a real-time tempo adjustment. In this way, a user can select to adjust the tempo of a song during playback and still have the appropriate pitch and visual synchronization to continue with the music instruction in real-time.

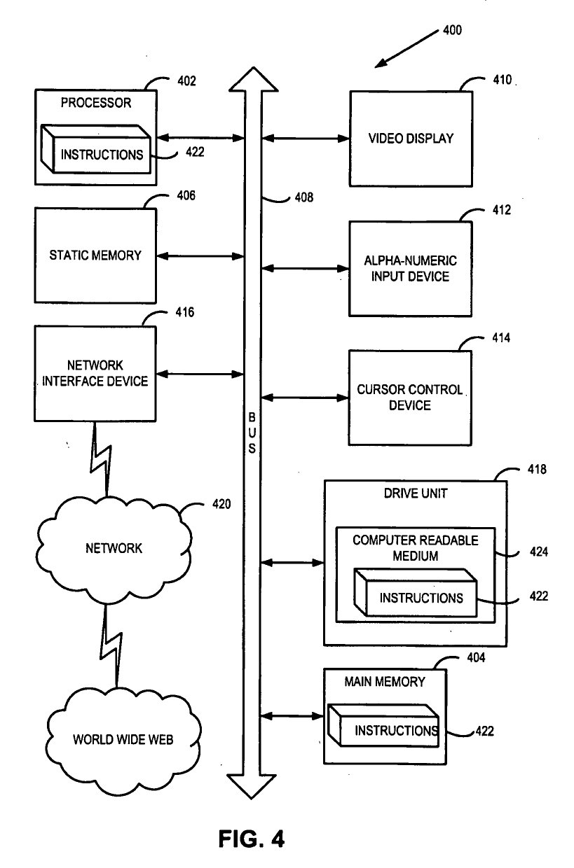

FIG. 4 illustrates a diagrammatic representation of a machine in the exemplary form of a computer system 400 within which a set of instructions, for causing the machine to perform any one or more of the methodologies discussed herein, may be executed. In alternative embodiments, the machine may be connected (e.g., networked) to other machines in a Local Area Network (LAN), an intranet, an extranet, or the Internet. The machine may operate in the capacity of a server or a client machine in a client-server network environment, or as a peer machine in a peer-to-peer (or distributed) network environment. The machine may be a personal computer (PC), a tablet PC, a set-top box (STB), a Personal Digital Assistant (PDA), a cellular telephone, or any machine capable of executing a set of instructions (sequential or otherwise) that specify actions to be taken by that machine. Further, while only a single machine is illustrated, the term “machine” shall also be taken to include any collection of machines (e.g., computers) that individually or jointly execute a set (or multiple sets) of instructions to perform any one or more of the methodologies discussed herein.

The exemplary computer system 400 includes a processor 402, a main memory 404 (e.g., read-only memory (ROM), flash memory, dynamic random access memory (DRAM) such as synchronous DRAM (SDRAM) or Rambus DRAM (RDRAM), etc.), a static memory 406 (e.g., flash memory, static random access memory (SRAM), etc.), and a secondary memory 416 (e.g., a data storage device), which communicate with each other via a bus 408.

Processor 402 represents one or more general-purpose processing devices such as a microprocessor, central processing unit, or the like. More particularly, the processor 402 may be a complex instruction set computing (CISC) microprocessor, reduced instruction set computing (RISC) microprocessor, very long instruction word (VLIW) microprocessor, a processor implementing other instruction sets, or processors implementing a combination of instruction sets. Processor 402 may also be one or more special-purpose processing devices such as an application specific integrated circuit (ASIC), a field programmable gate array (FPGA), a digital signal processor (DSP), network processor, or the like. Processor 402 is configured to execute the processing logic 422 for performing the operations and steps discussed herein.

The computer system 400 may further include a network interface device 416. The computer system 400 also may include a video display unit 410 (e.g., a liquid crystal display (LCD) or a cathode ray tube (CRT)), an alphanumeric input device 412 (e.g., a keyboard), and a cursor control device 414 (e.g., a mouse)

The secondary memory 418 may include a machine-readable storage medium (or more specifically a computer-readable storage medium) 424 on which is stored one or more sets of instructions (e.g., software 422) embodying any one or more of the methodologies or functions described herein. The software 422 may also reside, completely or at least partially, within the main memory 404 and/or within the processing device 402 during execution thereof by the computer system 400, the main memory 404 and the processing device 402 also constituting machine-readable storage media. The software 422 may further be transmitted or received over a network via the network interface device 416.

While the computer-readable storage medium 424 is shown in an exemplary embodiment to be a single medium, the term “computer-readable storage medium” should be taken to include a single medium or multiple media (e.g., a centralized or distributed database, and/or associated caches and servers) that store the one or more sets of instructions. The term “computer-readable storage medium” shall also be taken to include any medium that is capable of storing or encoding a set of instructions for execution by the machine and that cause the machine to perform any one or more of the methodologies of the present invention. The term “machine readable storage medium” shall accordingly be taken to include, but not be limited to, solid-state memories, and optical and magnetic media.

Various components described herein may be a means for performing the functions described herein. Each component described herein includes software, hardware, or a combination of these. The operations and functions described herein can be implemented as software modules, hardware modules, special-purpose hardware (e.g., application specific hardware, application specific integrated circuits (ASICs), digital signal processors (DSPs), etc.), embedded controllers, hardwired circuitry, etc.

Aside from what is described herein, various modifications may be made to the disclosed embodiments and implementations of the invention without departing from their scope. Therefore, the illustrations and examples herein should be construed in an illustrative, and not a restrictive sense.

What is claimed is:

1. A computer-implemented method, comprising:
playing an audio of a song;
displaying a graphical representation of a musical instrument associated with the audio;
overlaying a fingering display on the graphical representation of the instrument during the playing of song, wherein the fingering is synchronized to the audio of the song;
adjusting the tempo of the song during the playing of the audio of the song;
substantially preserving in real-time a pitch of the song in view of the adjusted tempo; and
maintaining in real-time the synchronization between the fingering display and the audio in view of the adjusted tempo.

2. The method of claim 1, further comprising:
displaying a video of the song;
synchronizing the fingering display and the audio with the video;
maintaining the synchronization between the fingering display, the audio and the video in view of the adjusted tempo.

3. The method of claim 1, further comprising:
displaying a musical notation of the song;
synchronizing the musical notation with the fingering display and the audio; and
maintaining the synchronization between the fingering display, the audio and the musical notation in view of the adjusted tempo.

4. The method of claim 1, wherein the instrument is a string instrument and the method further comprises:
displaying vibration of respective strings in the graphical representation of the instrument during the playing of the song, the vibrations synchronized with the audio and the fingering display.

5. The method of claim 4, wherein the vibrations match a length and an intensity of acoustic vibrations associated with the string instrument in the song.

6. The method of claim 1, wherein the instrument is a keyboard/piano and the method further comprises:
displaying movement of respective keyboard/piano keys in the graphical representation of the instrument during the playing of the song, the movement of the keyboard/piano keys synchronized with the audio and the fingering display.

7. The method of claim 1, wherein the adjusting of the tempo comprises:
performing a sample rate conversion on the audio.

8. A computer-readable storage medium containing instructions that, when executed, cause a computer to:
play an audio of a song;
display a graphical representation of a musical instrument;
overlay a fingering display on the graphical representation of the instrument during the playing of song, wherein the fingering is synchronized to the audio of the song;
adjust the tempo of the song during the playing of the audio of the song;
substantially preserve in real-time a pitch of the song in view of the adjusted tempo; and
maintain in real-time the synchronization between the fingering display and the audio in view of the adjusted tempo.

9. The computer-readable storage medium of claim 8, wherein the instructions comprise further instructions to cause the computer to:
display a video of the song;
synchronize the fingering display and the audio with the video;
maintain the synchronization between the fingering display, the audio and the video in view of the adjusted tempo.

10. The computer-readable storage medium of claim 8, wherein the instructions comprise further instructions to cause the computer to:
display a musical notation of the song;
synchronize the musical notation with the fingering display and the audio; and
maintain the synchronization between the fingering display, the audio and the musical notation in view of the adjusted tempo.

11. The computer-readable storage medium of claim 8, wherein the instrument is a string instrument and the wherein the instructions comprise further instructions to cause the computer to:
display vibration of respective strings in the graphical representation of the instrument during the playing of the song, the vibrations synchronized with the audio and the fingering display.

12. The computer-readable storage medium of claim 8, wherein the instrument is a keyboard/piano and the wherein the instructions comprise further instructions to cause the computer to:
display movement of respective keyboard/piano keys in the graphical representation of the instrument during the playing of the song, the movement of the keyboard/piano keys synchronized with the audio and the fingering display.

13. The computer-readable storage medium of claim 8, wherein the instructions to cause the adjusting of the tempo comprise further instructions that cause the computer to:
perform a sample rate conversion on the audio.

14. A system, comprising:
a graphical user interface (GUI);
an audio module to play an audio of a song;
a video module to display a video of the song in the GUI;
an instrument module having a graphical element resembling at least a portion of a musical instrument, the graphical element to be displayed in the GUI;
a fingering module to overlay instrument fingering on the instrument displayed in the GUI during playback of the song;
a tempo slider having a graphical element displayed in the GUI, the tempo slider to adjust a tempo of the song audio in real-time during playback of the song; and
a synchronization module to synchronize the audio, the video and the instrument fingering.

15. The system of claim 14, wherein the instrument module includes a vibration component that causes strings on a string instrument to visually vibrate during playback of the song.

16. The system of claim 15, the synchronization module further to synchronize the vibration of the strings at least with the audio and the instrument fingering.

17. The system of claim 14, wherein the tempo slider further comprises:
a pitch stabilizer to stabilize a pitch of the song audio in real-time in response to an adjustment of tempo during playback of the song.

18. The system of claim 14, further comprising:
a music notation module having a graphical element to display music notation corresponding to the song in the GUI according to one of a tab, a chord, a chord grid or a classical notation; and
the synchronization module further to synchronize the music notation with the audio, video and the instrument fingering.

19. The system of claim 12, further comprising:
an instrument tuner having a graphical element displayed in the GUI, the instrument tuner to provide tuning feedback to a user in response to a selection of an instrument string from the instrument displayed in the GUI and receiving audio input from an external instrument; and
a mixer having a graphical element displayed in the GUI, the mixer to apply user-configurable audio mixing parameters to at least one of the song audio and the external instrument audio.
